(19) United States
(12) Patent Application Publication
(10) Pub. No.: US 2026/0102777 A1
(43) Pub. Date: Apr. 16, 2026

(54) METHOD AND APPARATUS FOR ELECTROSTATIC SEPARATION OF GLANDULAR TRICHOMES

(71) Applicant: Charles MacGowan, Miami, FL (US)

(72) Inventor: Charles MacGowan, Miami, FL (US)

(21) Appl. No.: 19/388,384

(22) Filed: Nov. 13, 2025

Related U.S. Application Data
(63) Continuation-in-part of application No. 18/654,997, filed on May 3, 2024, now Pat. No. 12,472,511.
(60) Provisional application No. 63/594,535, filed on Oct. 31, 2023.
(60) Provisional application No. 63/102,008, filed on Nov. 13, 2024.

(51) Int. Cl. B03C 7/12; B03C 7/08

(52) U.S. Cl. CPC B03C 7/12; B03C 7/08

(57) ABSTRACT

An electrostatic separation apparatus and method are provided for isolating glandular trichomes from trichome-bearing plant biomass such as cannabis, hemp, or hops. The system may include a vertically oriented particle transport assembly configured to convey a sample through a linear free-fall pathway, a separation chamber with opposing electrode assemblies generating a uniform electrostatic field, and discharge electrodes positioned below the chamber to neutralize residual charge. Airflow regulation may be achieved through laminar diffuser plates and periodic vibration of critical components, including the hopper and diffuser, to prevent clogging and maintain uniform flow. The hopper may further include a circular discharge spout and rounded internal fillets to prevent bridging and ensure consistent powder recirculation. The apparatus achieves high-purity trichome separation through controlled field exposure, aerodynamic stabilization, and charge-neutralized particle discharge, enabling continuous, high-throughput operation with improved yield, reduced maintenance, and enhanced reproducibility across successive processing cycles.

### CLAIM OF PRIORITY

This application is a Continuation-In-Part (CIP) of U.S. Non-Provisional patent application Ser. No. 18/654,997, filed on May 3, 2024, which is set to grant on Nov. 18, 2025 as U.S. Pat. No. 12,472,511, which in turn claims the benefit of U.S. Provisional Patent Application Ser. No. 63/594,535 filed on Oct. 31, 2023. This application also claims the benefit of U.S. Provisional Application No. 63/102,008, filed Nov. 13, 2024. The foregoing applications are incorporated by reference herein in their entireties.

### BACKGROUND OF THE INVENTION

### Field of the Invention

The present invention relates generally to particle separation systems and methods, and more specifically to electrostatic separation of glandular trichomes from trichome-bearing plant biomass. The invention pertains to improvements in process control, charge management, and material flow during electrostatic separation, including structural and operational enhancements that improve purity, yield, and operational stability during continuous processing of botanical materials.

### Description of the Related Art

The separation of glandular trichomes from botanical materials such as cannabis and hemp has historically relied on mechanical, pneumatic, and electrostatic processes that seek to isolate the resinous gland heads from surrounding plant matter. In many existing designs, electrostatic separators utilize triboelectric charging to differentiate between trichomes and fibrous material. In these configurations, the particulate biomass is conveyed through a coiled or spiral conduit designed to impart charge through repeated collisions between particles and the tube walls. The oppositely charged particles are then exposed to an electric field, where they are deflected toward distinct collection regions based on their charge polarity and mass-to-charge ratio.

While triboelectric-based separators are theoretically capable of achieving charge-dependent separation, they exhibit significant practical limitations that restrict their efficiency and scalability. The use of coiled or spiral conduits increases surface area contact, leading to particle adhesion and accumulation of residual material. Over time, these retained materials contaminate subsequent batches and distort charge uniformity, resulting in unstable field conditions and diminished product purity. The coiled geometry also creates regions of low flow velocity that encourage particle settling, compaction, and blockages. Cleaning and reassembling such conduits often require extensive downtime, making continuous industrial operation difficult to sustain.

A further shortcoming of triboelectric separators is their reliance on uncontrolled physical interactions to generate charge. Factors such as relative humidity, particle composition, and temperature variability cause unpredictable differences in charge magnitude and polarity. These inconsistencies result in unreliable particle trajectories through the electric field, producing poor reproducibility across runs. Moreover, the high magnitude of charge generated within the transport tubing can lead to excessive inter-particle cohesion, commonly observed as clustering or agglomeration of resinous material. When clusters of particles behave as a single entity, electrostatic separation becomes ineffective, as the cluster responds to the electric field as a bulk mass rather than as individual particles.

In addition to triboelectric inconsistencies, conventional systems lack mechanisms for pre-separation de-agglomeration. Resinous powders tend to form cohesive masses due to van der Waals forces and static charge accumulation during storage or handling. Without a dedicated declumping process, these aggregates enter the separation chamber as irregular clumps that compromise uniform field exposure. Attempts to break up these clusters using pneumatic jets or sieving mechanisms have proven unreliable. Pneumatic jets, while effective in dispersing aggregates, also cause turbulence that disrupts laminar flow conditions within the separator, while mechanical sieving introduces contamination and mechanical wear.

Another area of concern is the management of airflow within the separation chamber. Electrostatic separators typically require air movement for transport and dust evacuation, but unregulated exhaust flow can cause substantial loss of fine particulate matter. The exhaust ports of conventional systems often generate localized high-velocity regions that capture and remove light trichome particles before they experience sufficient electrostatic deflection. This “carry-out” loss not only reduces yield but also introduces variability in product recovery from batch to batch. Some systems employ static mesh diffusers or baffles to slow the exhaust velocity, but these components tend to accumulate fine residues, which can degrade electric field uniformity and increase cleaning frequency.

The structural geometry of electrode plates further contributes to process inefficiencies. In many systems, electrodes are configured with relatively small aspect ratios—plates that are approximately square or only marginally taller than wide. As particles fall between these electrodes, their residence time within the electric field is limited. Short residence times are insufficient for meaningful charge-based separation to occur, particularly when the particles vary in size and composition. Increasing residence time by adjusting plate geometry has been shown to improve selectivity, but existing designs rarely incorporate optimized plate dimensions.

Electrode surface finish also plays a critical role in determining separation behavior. Highly polished electrodes allow partially charged particles to slide prematurely under gravity or airflow before effective field interaction, whereas excessively rough surfaces trap fine material and reduce active field area. Systems employing untreated stainless steel or aluminum plates often experience rapid fouling, which diminishes both collection efficiency and the stability of the electrostatic field. Inadequate control over surface texture results in inconsistent separation and frequent maintenance cycles.

Another persistent issue in existing systems involves powder discharge after separation. Once particles exit the electric field, they often retain residual charge. Charged powders adhere to metallic hoppers and funnel walls, forming bridges and blockages that disrupt flow. Bridging commonly occurs at internal corners and square discharge spouts, where particles form stable arches that resist gravity-driven movement. These interruptions reduce throughput and require manual clearing, thereby increasing downtime. Some systems attempt to address this issue using mechanical agitators or compressed air jets, but such methods introduce unwanted complexity, potential contamination, and additional maintenance requirements.

Charge accumulation during operation further exacerbates adhesion problems. Particles that recycle through the system without neutralization can progressively increase in charge magnitude, making them increasingly cohesive. The resulting electrostatic clumping not only reduces material mobility but also disturbs downstream collection accuracy. Few existing designs incorporate charge-neutralization stages to reset powder charge states before recirculation. Without active discharge management, performance gradually degrades over successive cycles.

Surface characteristics of downstream collection and discharge components also influence material flow stability. Hoppers fabricated with satin or brushed finishes tend to exhibit moderate friction that retains fine powder residues, whereas overly smooth surfaces can promote uncontrolled sliding that causes segregation of heavier and lighter particles. A balance between smoothness and controlled adhesion is necessary to maintain consistent discharge flow without accumulation or uneven particle migration.

Mechanical vibration has been used in some powder-handling applications to mitigate bridging and adhesion. However, prior art systems applying vibration indiscriminately often encounter unintended effects. Excessive vibration can introduce new charge through frictional contact or cause premature particle detachment from electrodes, while insufficient vibration fails to dislodge agglomerated material. Similarly, vibratory diffusers used to stabilize laminar flow have shown promise in preventing clogging of mesh diffusers, but their frequency and amplitude must be carefully tuned to prevent disturbance of the electric field.

Flow-conditioning diffusers at the separator inlet are likewise subject to operational challenges. Over time, resinous particles accumulate within the mesh apertures of laminar diffusers, distorting flow uniformity and reducing separation consistency. As temperature and humidity vary, resin softening and condensation exacerbate clogging, necessitating frequent cleaning. Clogged diffusers disrupt particle trajectories, resulting in irregular charge distribution and increased loss of light fractions.

Collectively, these limitations reveal systemic shortcomings in existing electrostatic trichome separation technology. The coiled triboelectric charging geometry introduces uncontrolled variables, the absence of effective declumping leads to agglomeration, and the lack of airflow control contributes to material loss. Short electrode lengths restrict residence time, while poor surface finishes degrade field integrity and cleaning efficiency. Inadequate charge management downstream of the separation region promotes bridging and adhesion, while hopper and diffuser geometries compound blockages over time.

Accordingly, there is a need in the art for improved electrostatic separation systems and methods that overcome these inefficiencies. Desired solutions should incorporate a streamlined particle transport path that minimizes wall contact and particle retention while promoting uniform vertical flow. Systems should further provide internal features that regulate exhaust flow and prevent particulate loss through diffuser-induced airflow control. Electrode assemblies should be dimensioned to provide sufficient residence time for selective deflection, while surface finishes should be optimized to balance temporary particle adhesion and reliable release. Moreover, charge management strategies such as controlled discharge and tuned vibration should be employed to ensure stable, continuous operation.

In addition, desired designs should address powder flow consistency within the hopper and collection assembly through structural modifications that reduce bridging and promote self-cleaning behavior. Circular discharge geometries and rounded internal transitions may eliminate stable bridging points, while surface treatments and vibratory mechanisms can further ensure uninterrupted powder discharge. Flow-conditioning elements such as laminar diffusers should be engineered to maintain stable flow profiles with minimal clogging, ideally incorporating self-clearing or periodically activated components to restore laminarity.

In summary, conventional electrostatic trichome separation systems are constrained by uncontrolled charge generation, inconsistent residence times, inadequate exhaust and discharge management, and geometric designs that favor material accumulation. There remains a significant need for systems that achieve precise charge control, stable flow conditions, and repeatable separation performance. Improved apparatus and methods should therefore aim to reduce dependence on triboelectric charging, enhance de-agglomeration capability, improve airflow regulation, optimize electrode exposure time, and minimize adhesion or bridging throughout the process pathway. By addressing these long-standing mechanical and electrostatic deficiencies, future separation technologies can achieve higher product purity, increased throughput, and reduced maintenance burdens compared to existing approaches.

### SUMMARY OF THE INVENTION

The present invention provides an improved method and apparatus for electrostatic separation of glandular trichomes from trichome-bearing plant biomass, wherein the system is engineered to control particle charge distribution, flow uniformity, and residence time within an electrostatic field. The apparatus may incorporate a vertically oriented, straight particle transport path configured to minimize triboelectric charging while maintaining laminar descent of particulate matter through the separation region. In various embodiments, the system may further include extended-length electrode plates arranged to increase electrostatic residence time, controlled diffuser structures for regulating airflow at the inlet and exhaust, and paired discharge electrodes positioned to neutralize residual charge downstream of the separation zone. Additional mechanical enhancements, such as vibratory hoppers with mirror-polished surfaces and rounded discharge geometries, may prevent powder bridging and promote continuous recirculation. Through the integration of optimized flow geometry, surface finishes, and discharge management, the invention enables high-efficiency, high-purity trichome recovery under stable and repeatable process conditions.

The present invention offers numerous advantages over prior electrostatic separation systems that rely on uncontrolled triboelectric charging and mechanically complex designs. Unlike conventional spiral or coiled-tube separators, the vertically oriented structure of the present invention reduces particle adhesion, simplifies cleaning, and eliminates unpredictable charge accumulation caused by excessive wall contact. The extended electrode length enhances residence time and selectivity, while the airflow diffuser system mitigates particulate loss through balanced exhaust flow control. By employing controlled vibration and surface treatments, the invention prevents material bridging within collection hoppers and maintains uninterrupted throughput. Furthermore, the inclusion of discharge electrodes to neutralize residual charge addresses the long-standing problem of electrostatic clumping, allowing continuous, automated operation without manual clearing or downtime. Collectively, these improvements result in significantly higher product purity, yield consistency, and process reliability compared to the limitations inherent in traditional triboelectric-based separation systems.

In a first implementation of the present invention, an apparatus is provided for electrostatic separation of glandular trichomes from a sample of trichome-bearing plant biomass. The apparatus generally comprises a particle transport assembly configured to vertically convey the sample through a free-fall pathway under gravitational influence, wherein the pathway is substantially linear and free of coiled or spiral conduits to reduce wall contact and minimize triboelectric charge accumulation. A separation chamber is disposed along the free-fall pathway and includes a pair of opposing electrode assemblies configured to generate an electrostatic field that deflects charged trichomes from the sample toward at least one collector surface for recovery. Positioned below the separation chamber is a pair of discharge electrodes located adjacent to the free-falling sample, the discharge electrodes being configured to neutralize residual charge on particles exiting the separation chamber so as to prevent clumping and wall adhesion during operation. A hopper is positioned downstream of the discharge electrodes and is formed with a mirror-polished internal surface finish and a circular discharge outlet configured to prevent powder bridging, reduce particle retention, and promote continuous downward flow. The apparatus further comprises a vibration mechanism operatively coupled to at least one of the hopper and a laminar diffuser, the vibration mechanism being configured to induce periodic vibration sufficient to dislodge adhered particles, maintain laminar flow conditions, and enable uninterrupted recirculation of the sample throughout continuous operation.

In a second aspect, the apparatus may further include a laminar diffuser positioned within the particle transport assembly and configured to regulate airflow velocity and maintain a uniform downward flow of the sample through the free-fall pathway, thereby stabilizing particle trajectories under gravitational influence.

In another aspect, the laminar diffuser may incorporate a perforated plate or multi-hole grid structure configured to diffuse exhaust airflow and prevent fine particulate entrainment or powder loss through an upper exhaust outlet of the separation chamber during operation.

In another aspect, each electrode assembly within the separation chamber may comprise an elongated conductive plate having a length-to-width ratio of at least two-to-one (2:1), such that the sample experiences an electrostatic field residence time sufficient to enable deflection and collection of glandular trichomes with a separation efficiency greater than ninety percent by weight.

In another aspect, the elongated conductive plate may include a unidirectional brushed surface finish characterized by an average surface roughness (Ra) ranging from approximately 0.8 to 1.2 micrometers and a ten-point mean roughness (Rz) ranging from approximately 4.0 to 6.0 micrometers, thereby enhancing trichome adherence during electrostatic deflection while maintaining consistent discharge behavior.

In another aspect, the discharge electrodes may comprise corona discharge electrodes arranged laterally adjacent to the descending powder stream and configured to neutralize charge on individual particles during free-fall prior to entry into the hopper to prevent clumping and hopper wall adhesion.

In another aspect, the vibration mechanism may include a pneumatic turbine vibrator or an electrically driven vibration actuator configured to impart periodic oscillations to the hopper structure to promote uniform powder descent, dislodge adhered particles, and maintain steady-state flow through the discharge outlet.

In another aspect, the hopper may be formed with all internal intersections defined by rounded fillets having a radius of curvature of at least twenty-five millimeters and may further include a circular discharge outlet configured to prevent geometric bridging, eliminate dead zones, and ensure uniform powder flow during continuous recirculation.

In another aspect of the present invention, the mirror-polished internal surface of the hopper may exhibit a surface roughness (Ra) of approximately 0.05 micrometers or less, thereby reducing the coefficient of friction between particles and the hopper surface, minimizing mechanical interlocking, and promoting efficient discharge of residual trichomes during extended operation.

In another implementation of the present invention, a method is provided for electrostatic separation of glandular trichomes from a sample of trichome-bearing plant biomass. The method generally includes vertically conveying the sample through a free-fall pathway under gravitational influence, the pathway being linear and uncoiled to minimize wall contact and reduce undesired triboelectric charging. The sample is guided through a laminar diffuser configured to declump agglomerated particles and maintain a steady, evenly distributed flow prior to entering a separation chamber. The method further includes subjecting the free-falling particles to an electrostatic field generated by a pair of oppositely charged electrode assemblies positioned on either side of the falling stream, such that glandular trichomes having a specific charge polarity are deflected toward a collector surface while non-target biomass continues through the separation zone. The method also includes positioning a pair of discharge electrodes below the separation chamber, the discharge electrodes operating to neutralize residual charge on the separated particles to prevent electrostatic clumping and promote efficient powder flow. Downstream of the discharge zone, the method involves collecting the separated material within a hopper having a mirror-polished internal surface and circular discharge outlet, thereby reducing friction, eliminating dead zones, and preventing powder bridging during continuous operation. The method further provides for periodic vibration of the hopper and laminar diffuser to dislodge adhered particles and maintain uninterrupted recirculation of material, thereby sustaining optimal flow dynamics and maximizing purity of the recovered trichomes.

In another aspect, the method may involve processing a sample comprising particles with an average size between approximately twenty and three hundred micrometers and a moisture content maintained between five and fifteen percent by weight, the controlled particle dimensions and moisture facilitating consistent electrostatic behavior and repeatable separation performance.

In another aspect, the method may include channeling the sample through a laminar diffuser comprising a perforated diffuser plate configured to regulate local airflow velocity and establish a uniform laminar flow field across the full cross-section of the separation chamber, thereby minimizing turbulence and ensuring consistent particle descent trajectories.

In another aspect, the laminar diffuser may be configured to undergo periodic vibration at a frequency between approximately one and sixty hertz to dislodge adhered particles, prevent clogging resulting from viscous biomass or electrostatic adhesion, and maintain stable laminar diffusion across extended operation intervals.

In another aspect, the electrode assemblies may comprise vertically oriented conductive plates having a length-to-width ratio of at least two-to-one (2:1), thereby extending residence time of particles within the electrostatic field and improving selectivity and yield of trichome separation.

In another aspect, each electrode plate may be formed with a brushed surface texture characterized by a surface roughness (Ra) between about 0.8 and 1.2 micrometers and a mean peak-to-valley roughness (Rz) between about 4.0 and 6.0 micrometers, the surface finish being configured to momentarily retain trichomes for charge-based differentiation before release into the collection zone.

In another aspect, the method may further employ discharge electrodes comprising a pair of corona discharge devices positioned laterally adjacent to the descending particle stream, the discharge devices being configured to emit ionized air that neutralizes residual charge on particles immediately below the separation chamber to prevent adhesion and enable smooth powder flow.

In another aspect of the invention, the hopper may include one or more pneumatic turbine or electrical vibration devices configured to induce oscillations that promote downward material movement and consistent discharge of separated powder into the recirculation conduit.

In another aspect, the hopper interior may be shaped with continuously curved surfaces having fillet radii of at least twenty-five millimeters and may terminate in a circular discharge outlet, the geometry being configured to prevent powder bridging and stagnant zones that would otherwise impede flow during continuous operation.

In another aspect of the present invention, the internal surfaces of the hopper may be mirror-polished to achieve a surface roughness (Ra) of approximately 0.05 micrometers or less, thereby reducing frictional adhesion of trichomes, minimizing material retention, and maintaining uninterrupted particle recirculation throughout high-throughput operation.

In another implementation of the present invention, a system is provided for automated electrostatic separation of glandular trichomes from trichome-bearing plant biomass. The system includes a vertically oriented electrostatic separation assembly configured to perform gravitational free-fall separation of particles through a laminar diffuser and between opposing electrode assemblies that generate a controlled electrostatic field. The system further comprises a series of sensors positioned throughout the assembly to monitor parameters including particle velocity, charge potential, temperature, and vibration frequency. A programmable control unit is operatively coupled to the sensors and configured to dynamically regulate at least one of the applied electrode potential, vibration frequency, or corona discharge intensity in real time to sustain laminar flow and prevent agglomeration. The system also incorporates a feedback loop employing adaptive control logic to automatically adjust operational parameters in response to detected variations in field strength or flow uniformity. By continuously optimizing electrostatic charge balance, particle distribution, and vibration amplitude, the system maintains a consistent trichome separation efficiency and purity while minimizing material loss and ensuring stable, high-throughput operation.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a schematic representation of an exemplary electrostatic separation apparatus illustrating the general system configuration for separating glandular trichomes from plant biomass, showing the arrangement of the particle dispenser, transport conduit, separation chamber, electrode assemblies, and collection pathway;

FIG. 2 presents a schematic representation of one embodiment of the electrode assembly, illustrating the relative orientation of opposing electrode plates and associated electrical connections for generating the electrostatic field utilized in trichome deflection;

FIG. 3 presents a schematic representation of an alternative embodiment of the electrode assembly, showing modified plate geometry and spatial configuration for optimizing electric field uniformity and trichome capture efficiency;

FIG. 4 presents a schematic block diagram representing one embodiment of the electrostatic separation method, showing sequential stages of sample dispensing, particle channeling, and electrostatic separation under controlled field conditions;

FIG. 5 presents a schematic block diagram representing an alternative embodiment of the electrostatic separation method incorporating a recirculation stage for re-processing residual material and enhancing overall trichome recovery yield;

FIG. 6 presents a front elevational view of an electrostatic separation system incorporating a straight vertical tube transport assembly in lieu of a coiled conduit, illustrating the linear free-fall pathway through which trichome-bearing plant material is pneumatically conveyed to promote deagglomeration, reduce wall adhesion, simplify cleaning and maintenance, and maintain a uniform gravitational flow essential for consistent electrostatic separation performance;

FIG. 7 presents a front perspective view of the electrostatic separation system illustrating a pair of perforated airflow diffuser plates positioned proximate the upper exhaust ports, the diffuser plates being configured to disrupt and evenly redistribute upward air currents to prevent fine particulate entrainment, reduce powder loss during exhaust flow, and maintain balanced pressure differentials across the separation chamber for improved yield and operational stability;

FIG. 8 presents a front perspective view of the electrostatic separation chamber incorporating elongated electrode plates extending along the vertical fall axis, each electrode plate being at least twice as long as its width (L/W≥2) to extend the residence time of particles within the electric field and thereby enhance the precision of trichome separation, reduce cross-contamination between charged and uncharged fractions, and improve collection efficiency during continuous gravitational free-fall operation;

FIG. 9 presents a detailed perspective view of the lower region of the electrostatic separation chamber, showing a pair of opposed discharge electrodes positioned laterally adjacent to the descending powder stream beneath the electrode plates, the discharge electrodes being configured to emit corona discharges that neutralize residual particle charge during free-fall to prevent electrostatic clumping, hopper wall adhesion, and flow obstruction, thereby ensuring continuous material discharge and stable high-throughput operation;

FIG. 10 presents a front elevation view of the lower hopper region illustrating the integration of pneumatic turbine vibrators mounted laterally along the hopper wall, the vibrators configured to impart controlled oscillations that promote downward movement of separated powder through the funnel and into the recirculation conduit, thereby mitigating clogging, reducing particle buildup, and maintaining steady-state flow despite minor electrostatic recharging effects induced by vibration;

FIG. 11 presents a top perspective view of the laminar diffuser assembly integrated with a pneumatic vibration actuator mounted on the diffuser housing, the actuator configured to deliver intermittent vibrational pulses to dislodge accumulated particulate matter resulting from electrostatic attraction, viscous resin buildup, or heat-induced adhesion, thereby maintaining laminar airflow uniformity, preventing clogging, and ensuring consistent particle dispersion through the diffuser during extended operation; and

FIG. 12 presents a bottom perspective view of the main hopper assembly showing a circular discharge spout and rounded internal fillets formed along all converging hopper walls, the geometry being specifically configured to eliminate sharp corners and prevent material bridging, thereby maintaining uniform powder flow and avoiding arch formation caused by compaction or electrostatic adhesion in square discharge configurations;

Like reference numerals refer to like parts throughout the several views of the drawings.

### DETAILED DESCRIPTION OF THE PREFERRED EMBODIMENT

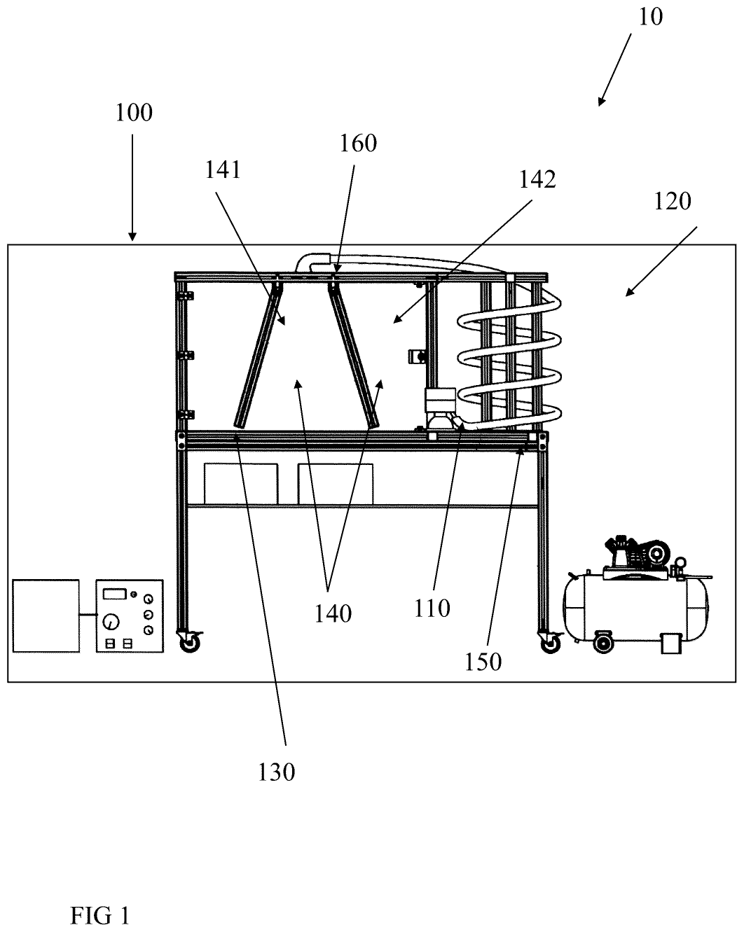

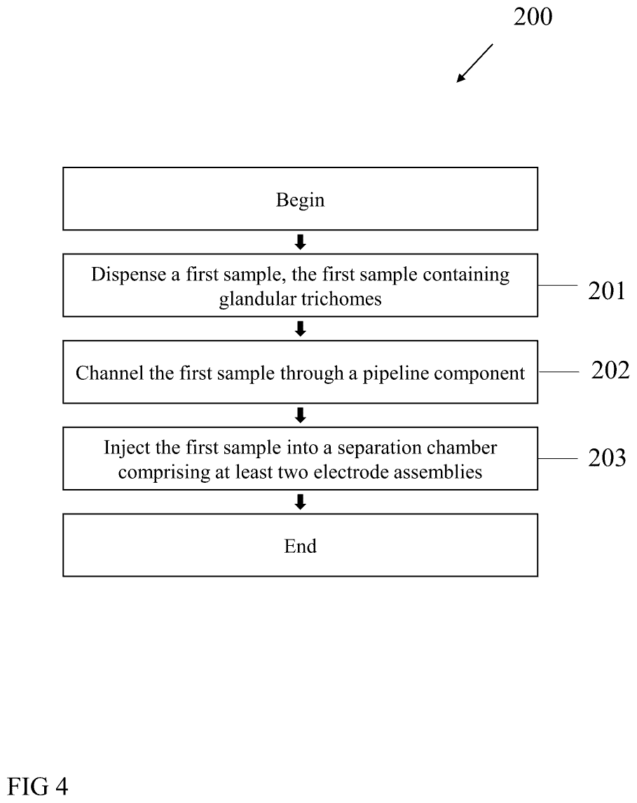

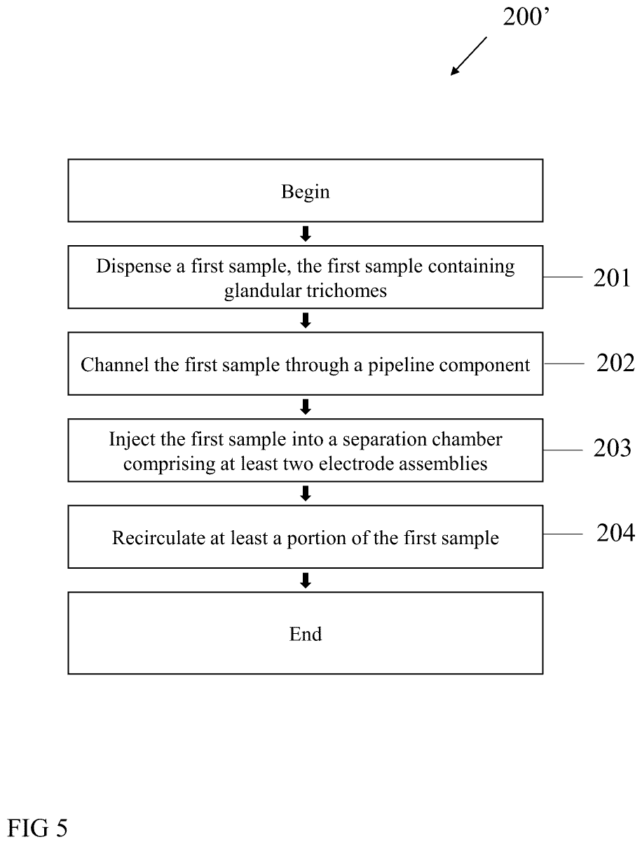

As shown throughout the figures, the present invention is directed to an apparatus for electrostatic separation of glandular trichomes, generally indicated as 10 in at least FIG. 1, and to attendant methods for electrostatic separation of glandular trichomes, generally represented as 200 in FIG. 4-5. As used herein, the term “about” refers to a variation of up to approximately ±5 percent from a stated value, as would be understood by one of ordinary skill in the art. With reference to FIG. 1, the apparatus for electrostatic separation of glandular trichomes 10 may comprise an electrostatic separation assembly 100 structured to prepare a sample of plant biomass for electrostatic separation and perform the selective separation of glandular trichomes from the sample. The electrostatic separation assembly 100 may be implemented as a single integrated system or as part of a multi-stage arrangement wherein multiple assemblies are connected in parallel or in series to achieve higher throughput or purity levels. In certain implementations, the electrostatic separation assembly 100 may be configured for mobile deployment, such as by integration into a transportable chassis or vehicle framework for field processing under controlled environmental conditions.

Referring still to FIG. 1, the electrostatic separation assembly 100 may include a dispensing component 110 configured to dispense a first sample comprising glandular trichomes contained within a trichome-bearing biomass. The dispensing component 110 may use vibrational or pneumatic feed mechanisms such as a vibrating dispenser, jet sieve, vacuum conveyor, or cyclone feeder to deliver the sample at a controlled rate. The first sample may be preconditioned by exposure to a controlled temperature between about −20° C. and 20° C. and a relative humidity between about 30 percent and 50 percent, each regulated by integrated thermal and humidity control elements. A pressurized gas source may also be applied to promote uniform distribution of particles within the sample, the gas being selected from dry atmospheric air or inert gases such as nitrogen or argon. The particle size of the first sample may range from about 20 to 300 micrometers, preferably below 250 micrometers, with a moisture content maintained between approximately 5 and 15 percent by weight. The moisture level may be continuously monitored by embedded sensors communicatively coupled to the control system of the electrostatic separation assembly 100 to ensure stable performance and consistent charge behavior during separation.

As further illustrated in FIG. 1, the electrostatic separation assembly 100 may comprise a pipeline component 120 configured to triboelectrically generate an electrostatic charge on the first sample during pneumatic conveyance. The pipeline 120 may be formed from a material capable of inducing charge separation upon contact, such as silicone, vinyl, fluoroethylene polymers, or polytetrafluoroethylene. The interior geometry of the pipeline 120 may be arranged to maximize surface interaction between the flowing sample and the pipeline wall, thereby imparting a uniform electrostatic potential before entry into the separation chamber. In certain embodiments, the pipeline 120 may be helically coiled to establish a circular aerodynamic flow that enhances charge consistency and particle mixing, although alternative geometries may be used to modulate triboelectric efficiency and reduce buildup. Charge generation within the pipeline 120 may result from frictional contact among particles within the first sample, between the particles and the pipeline surface, or from a combination of both, allowing controlled adjustment of charge magnitude through manipulation of flow rate, material composition, or surface finish.

The electrostatic separation assembly 100 may further include a flow regulation component 150 arranged to pneumatically control the rate, pressure, and velocity of the first sample as it moves through the pipeline 120. The flow regulation component 150 may include airflow regulators, vibrating feeders, or vacuum-based throttling elements to maintain a steady-state flow regime conducive to consistent charging and separation performance. The mass flow rate may vary between approximately 0.1 milligrams per minute and 10 kilograms per minute depending on operational parameters. Control signals may be electronically modulated based on feedback from in-line pressure or velocity sensors to maintain optimal laminar transport and repeatable separation quality.

Still referring to FIG. 1, the electrostatic separation assembly 100 may incorporate a separation chamber 130 comprising at least one electrode assembly 140. The separation chamber 130 may define a vertical free-fall region in which charged particles of the first sample are subjected to a controlled electric field that selectively deflects trichomes toward designated collection surfaces. Each electrode assembly 140 may include a first electrode 141 and a second electrode 142 arranged in opposing polarity to generate the electrostatic field. The electrodes may be flat, curved, or otherwise contoured to shape the field distribution. The applied voltage may range from about 3 kilovolts to 20 kilovolts and may be generated as sinusoidal, square, triangular, or composite waveforms with frequencies between 0 hertz and 300 kilohertz. The separation efficiency may depend upon the uniformity of the field, which is inversely proportional to the distance between electrodes; thus, parallel orientation of the first and second electrodes 141, 142 is generally preferred. Each electrode assembly 140 may optionally include an insulating or dielectric coating to minimize arcing and facilitate surface cleaning during extended use.

The electrostatic separation assembly 100 may further comprise an injection component 160 structured to deliver the first sample from the pipeline 120 into the separation chamber 130. The injection component 160 may function as a flow straightener that transitions the sample from turbulent motion within the pipeline to a laminar downward flow within the separation chamber. The injection aperture may be configured to constrict and homogenize the particle stream, promoting uniform distribution across the electric-field region. Under gravitational influence, the first sample may descend freely through the chamber while experiencing electrostatic deflection, with oppositely charged trichomes being attracted toward the appropriate electrode.

Following separation, the trichomes may be collected for subsequent refinement or incorporation into therapeutic, nutraceutical, or cosmetic products. In some embodiments, trichomes may be recovered directly from the electrode surface through mechanical scraping or electrical field release, while in others, trichomes may fall into collection bins positioned beneath the separation chamber after disengagement from the applied field. A single separation cycle may achieve purities of approximately 95 percent by weight, with subsequent recirculation cycles capable of reaching purities exceeding 99.9 percent.

To further enhance system throughput, the electrostatic separation assembly 100 may include a recirculation component configured to redirect a portion of incompletely separated material through the apparatus for additional passes. The recirculation component may utilize pneumatic channels or gravity-assisted conduits integrated into the overall housing of the assembly 100, allowing continuous feed operation without manual reloading.

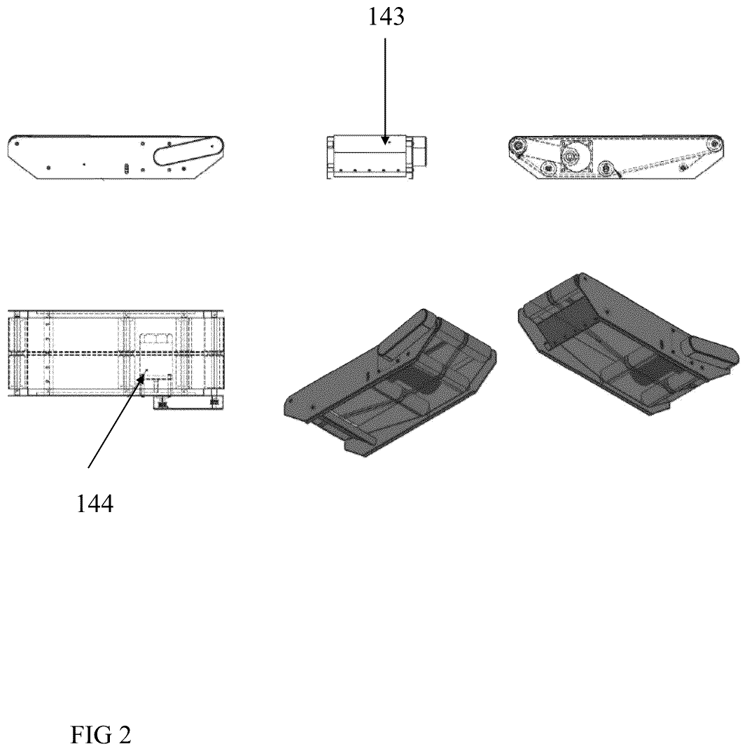

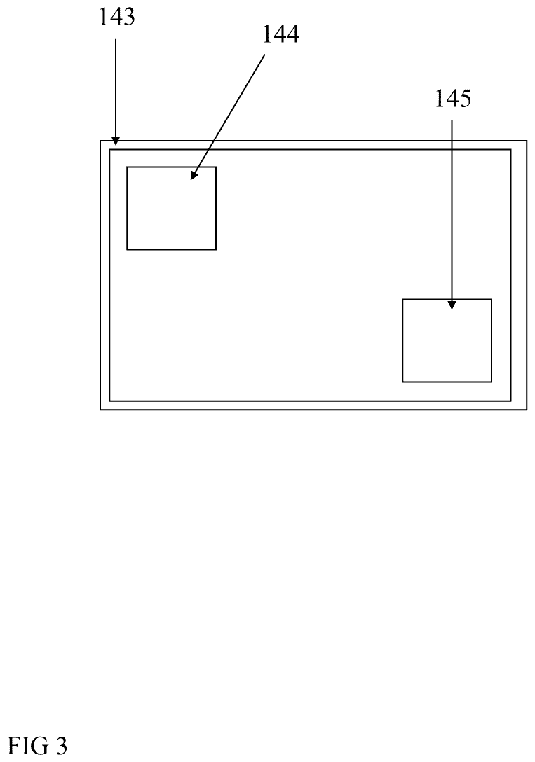

Referring now to FIGS. 2 and 3, each electrode assembly 140 may incorporate a self-cleaning configuration to maintain separation efficiency and reduce operational downtime. Each electrode assembly 140 may include an electroconductive belt 143 positioned along its active face, a motor 144 configured to rotate the belt 143, and a scraper 145 arranged to remove accumulated particulate matter. The scraper 145 may be fabricated from dielectric materials to prevent charge interference while mechanically detaching trichomes from the belt 143. In some embodiments, the scraper 145 may take the form of a brush or flexible wiper positioned along the distal region of the electrode assembly to continuously remove deposited material. Each self-cleaning electrode assembly may further comprise a transmission wheel and tension mechanism that maintain belt alignment and controlled rotational speed during operation.

In embodiments employing dual electrode assemblies 140, each electroconductive belt 143 may rotate either in the same direction or in opposite directions at adjustable speeds. The belt speed may be modulated according to the detected buildup of material on the electrode surface, as determined by integrated optical or capacitive sensors. The motor 144 of each electrode assembly 140 may operate independently, allowing discrete adjustment to optimize cleaning frequency and electrostatic balance across the chamber. The self-cleaning configuration may ensure consistent field strength, minimize charge interference, and preserve collection uniformity over continuous operation cycles.

Turning to FIGS. 4 and 5, the attendant method of the present invention, generally indicated as 200 and 200′, may encompass the procedural sequence by which glandular trichomes are separated from a sample of plant biomass. The method 200 may include dispensing a first sample 201 containing glandular trichomes, channeling the first sample through a pipeline component 202 that imparts triboelectric charge, and injecting the charged sample into a separation chamber containing at least one electrode assembly 203. The separation chamber 130 may be operated under gravitational flow conditions, allowing the charged particles to free-fall through the electrostatic field, during which the trichomes are deflected toward their corresponding electrodes for selective collection.

As further shown in FIG. 5, the method 200′ may include regulating temperature, humidity, and airflow prior to separation, controlling the pneumatic transport velocity through a flow regulation component, and collecting the separated trichomes for downstream use. The method may optionally include recirculating at least a portion of the sample 204 for additional processing passes to increase product purity. The system may thus be operated in a continuous or batch configuration, maintaining high efficiency while accommodating variation in feedstock properties.

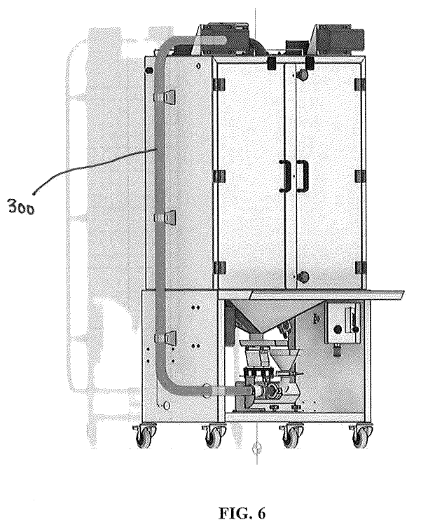

Referring first to FIG. 6, the electrostatic separation system may include a straight vertical tube transport assembly 300 arranged in lieu of the spiral conduit previously described, the assembly 300 configured to provide a linear free-fall pathway through which trichome-bearing plant material is pneumatically conveyed downward into the separation chamber. The linear geometry minimizes curvature-induced turbulence, thereby preserving laminar flow continuity and maintaining predictable particle trajectories under gravitational acceleration. The arrangement also promotes natural deagglomeration of cohesive biomass clusters through unidirectional acceleration, reducing static wall adhesion and eliminating material retention zones associated with curved or coiled tubing. The vertical orientation further simplifies cleaning and maintenance by providing unobstructed access from top to bottom, enabling mechanical or pneumatic flushing cycles to be performed without disassembly. Through this structural simplification, the apparatus maintains a consistent gravitational flow profile essential for repeatable electrostatic exposure and uniform charge distribution, thus ensuring improved reproducibility across consecutive separation cycles.

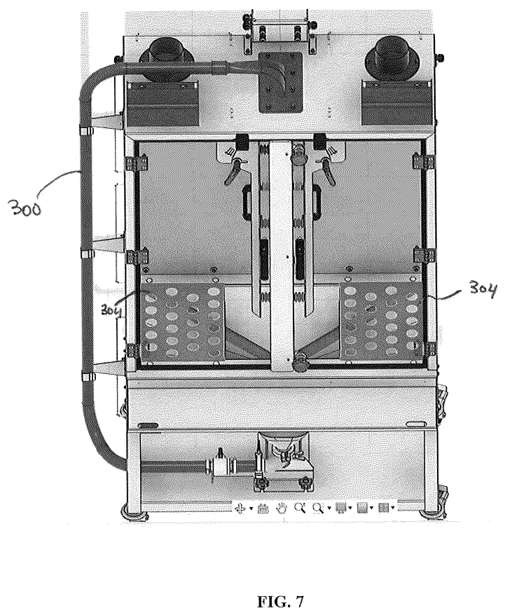

Turning to FIG. 7, the electrostatic separation chamber may include a pair of perforated airflow diffuser plates 304 positioned proximate the upper exhaust ports, the plates 304 functioning as laminar diffusers that homogenize upward airflow within the chamber to prevent fine particulate entrainment and premature loss of lightweight trichomes. Each diffuser plate may define an array of uniformly spaced apertures sized to balance exhaust velocity across the full cross-sectional area of the chamber, thereby dissipating concentrated air jets before they exit through the outlet manifold. By diffusing the exhaust stream in this manner, the diffuser plates maintain stable pressure equilibrium between the upper and lower chamber regions, preventing backdrafts or vortex formation that could otherwise disturb descending particles. The perforated geometry additionally acts as a physical barrier limiting powder escape during transient flow fluctuations, thus improving yield efficiency by retaining airborne trichomes until complete charge-based deflection and collection occur. The diffusers may be easily removable for cleaning and may be fabricated from conductive or semi-conductive materials to prevent static accumulation and fouling during operation.

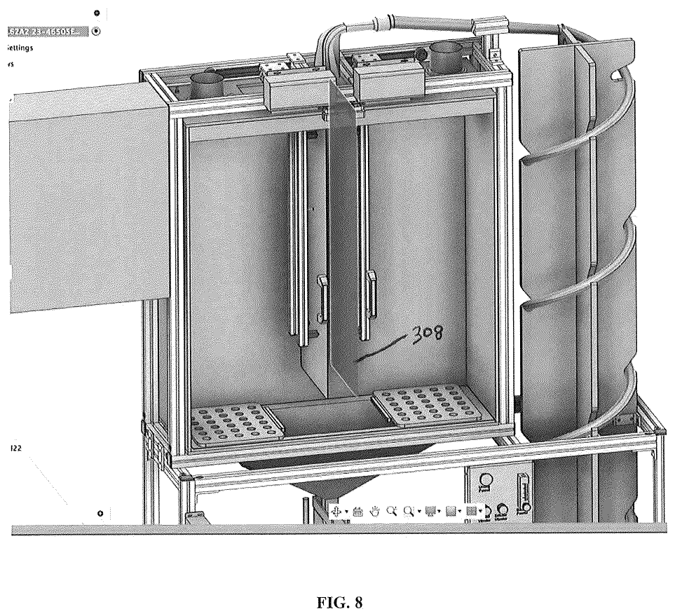

As depicted in FIG. 8, the separation chamber may incorporate elongated electrode plates 308 extending vertically along the central free-fall axis, each plate being formed with a length-to-width ratio greater than 2:1 to increase the effective residence time of particles within the established electrostatic field. This elongated geometry allows particles to remain exposed to the field for a longer interval while descending under gravity, thereby enabling more complete charge migration and enhanced discrimination between trichome and biomass fractions. The extended plates further minimize edge effects by producing a more uniform electric field gradient across the particle trajectory, which reduces cross-contamination and ensures stable deflection angles over continuous flow cycles. The electrodes may be constructed of highly conductive material such as aluminum or stainless steel and may be supported by dielectric standoffs to maintain precise spacing relative to opposing plates. In some configurations, the plate surfaces may exhibit a unidirectional brushed finish to facilitate controlled trichome adhesion while avoiding excessive fouling or film buildup. Overall, the vertical elongation of the electrode structure provides a scalable configuration for industrial-scale processing while preserving field stability and charge uniformity.

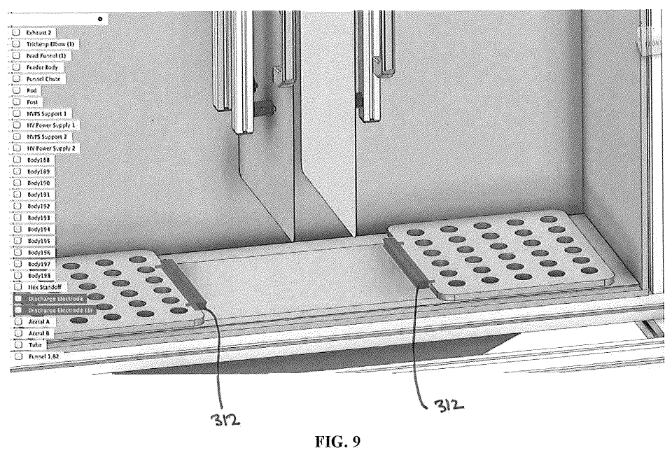

With reference to FIG. 9, the lower region of the separation chamber may further include a pair of opposed discharge electrodes 312 positioned laterally adjacent to the descending powder stream immediately below the main electrode zone. These discharge electrodes 312 are configured to emit corona discharges that neutralize residual charge on individual particles before entry into the hopper, preventing electrostatic clumping, wall adhesion, or bridging that could interfere with downstream material flow. The placement of these electrodes ensures that both positively and negatively charged particles experience sufficient neutralization prior to contact with any grounded surfaces, thereby restoring electrostatic equilibrium and enabling reliable recirculation of partially processed material. The electrodes may operate in pulsed or continuous discharge mode depending on feed rate and chamber load, and may be electrically isolated to allow independent control of ion emission polarity and magnitude. This localized neutralization mechanism eliminates particle buildup in lower chamber corners and promotes consistent discharge into the hopper funnel for high-throughput operation.

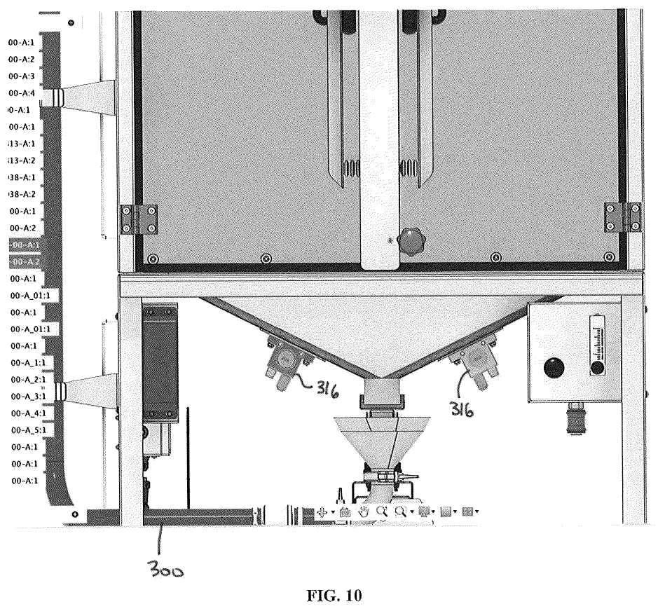

As shown in FIG. 10, the lower hopper section 316 may incorporate pneumatic turbine vibrators mounted laterally along the hopper walls, the vibrators configured to impart controlled oscillatory motion to promote downward movement of separated powder through the funnel outlet. These vibrators generate fine-frequency mechanical impulses that overcome interparticle friction and prevent cohesive arch formation above the discharge spout. The vibration frequency may be adjusted dynamically based on hopper fill level, particle load, or sensed flow resistance to maintain steady-state mass transfer into the recirculation conduit. Although vibration can induce minor triboelectric recharging of particles, this effect is outweighed by the improved evacuation efficiency and the prevention of stagnant accumulation zones that otherwise necessitate manual clearing. The vibratory subsystem therefore provides a mechanical aid to flow regulation without compromising electrostatic purity, and its integration is critical for maintaining process continuity during extended separation cycles.

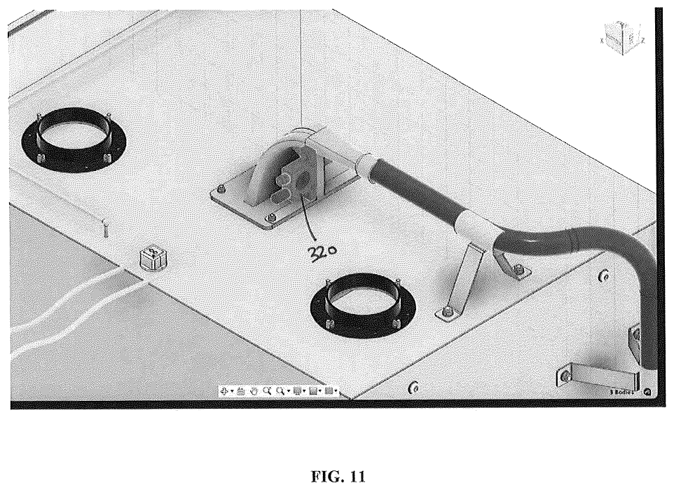

Referring now to FIG. 11, the laminar diffuser assembly 320 may be fitted with a pneumatic vibration actuator mounted directly to its housing, the actuator configured to deliver intermittent vibrational pulses to dislodge accumulated particulate matter resulting from electrostatic attraction or resinous adhesion. In some cannabis species or environmental conditions, trichome resin softens and promotes clogging of diffuser apertures; the introduction of vibrational energy periodically breaks loose this buildup to maintain consistent airflow distribution. The actuator may be operated on a timed cycle or triggered automatically via differential-pressure sensors monitoring airflow resistance across the diffuser plate. This design ensures continuous laminar flow integrity within the chamber, minimizing localized turbulence and maintaining the uniform downward air column required for precision separation. The combination of diffuser pulsation and controlled vibration substantially extends maintenance intervals, prevents heat-related fouling, and preserves consistent mass flow even when handling resinous or temperature-sensitive biomass.

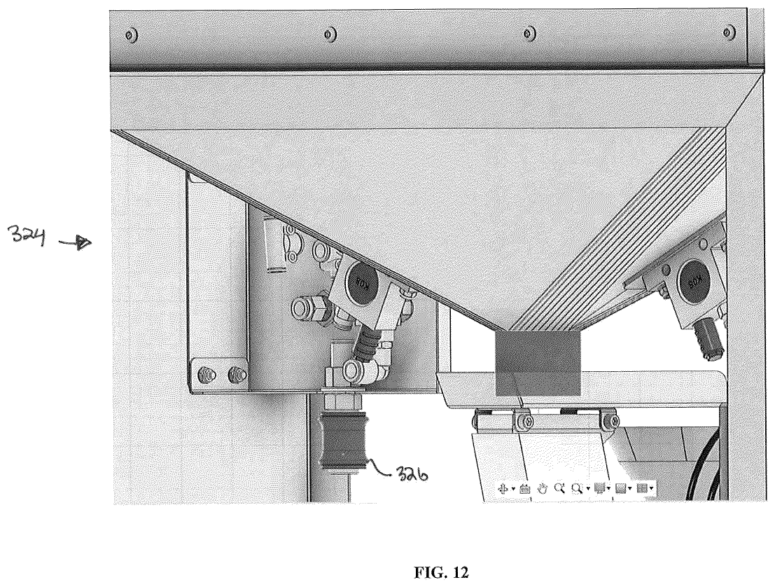

Finally, FIG. 12 illustrates the main hopper assembly 324 configured with a circular discharge spout 326 and smooth internal fillets formed along all converging hopper walls. Each transition between planar surfaces is replaced with a continuous radius of curvature of at least 25 millimeters to eliminate sharp corners and thereby remove geometric supports for bridging under bulk powder loads. The circular outlet ensures axisymmetric flow convergence, preventing dead zones where material could compact and obstruct discharge. This configuration also reduces mechanical shear forces and minimizes triboelectric charge regeneration during flow, maintaining stable powder conductivity for subsequent processing. The smooth filleted surfaces may be mirror-polished to further reduce surface roughness and adhesion, resulting in self-cleaning flow behavior that facilitates complete evacuation of trichomes after each cycle. Collectively, this hopper geometry ensures reliable powder recirculation, eliminates manual intervention, and supports fully automated continuous separation operation across varied material types.

Since many modifications, variations, and changes in detail may be made to the described preferred embodiment of the present invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. An apparatus for electrostatic separation of glandular trichomes from a sample of trichome-bearing plant biomass, comprising:
a particle transport assembly configured to vertically convey the sample through a free-fall pathway under gravitational influence, the pathway being substantially linear and free of coiled or spiral conduits to reduce wall contact and minimize triboelectric charge accumulation;
a separation chamber disposed along the free-fall pathway, the separation chamber comprising a pair of opposing electrode assemblies configured to generate an electrostatic field for deflecting charged trichomes from the sample toward at least one collector surface;
a pair of discharge electrodes positioned below the separation chamber and adjacent to the free-falling sample, the discharge electrodes configured to neutralize residual charge on particles exiting the separation chamber to prevent clumping and wall adhesion;
a hopper positioned downstream of the discharge electrodes, the hopper having a mirror-polished internal surface finish and a circular discharge outlet configured to prevent powder bridging and promote continuous discharge; and
a vibration mechanism operatively coupled to at least one of the hopper and a laminar diffuser, the vibration mechanism configured to induce periodic vibration sufficient to dislodge adhered particles, maintain laminar flow, and enable uninterrupted recirculation of the sample during continuous operation.

2. The apparatus of claim 1, wherein the particle transport assembly further comprises a laminar diffuser configured to regulate air velocity and maintain uniform downward flow of the sample through the free-fall pathway.

3. The apparatus of claim 2, wherein the laminar diffuser includes a perforated plate or multi-hole grid structure configured to diffuse exhaust airflow and prevent fine particulate entrainment or loss through an outlet port of the separation chamber.

4. The apparatus of claim 1, wherein each of the electrode assemblies in the separation chamber comprises an elongated conductive plate having a length-to-width ratio of at least 2:1, such that the sample experiences an electrostatic field residence time sufficient to achieve separation efficiency greater than 90 percent by weight.

5. The apparatus of claim 4, wherein the elongated conductive plate has a unidirectional brushed surface finish characterized by an average surface roughness Ra between 0.8 and 1.2 micrometers and an Rz between 4.0 and 6.0 micrometers, thereby enhancing trichome adhesion during electrostatic deflection.

6. The apparatus of claim 1, wherein the discharge electrodes comprise corona discharge electrodes positioned laterally adjacent to a descending powder stream and configured to neutralize charge on individual particles during free-fall prior to entry into the hopper.

7. The apparatus of claim 1, wherein the vibration mechanism is a pneumatic turbine vibrator or an electrically driven vibration actuator configured to periodically oscillate the hopper to promote downward flow and prevent particle buildup.

8. The apparatus of claim 1, wherein the hopper has all internal edges formed as rounded fillets having a radius of curvature of at least 25 millimeters and a circular discharge outlet to prevent geometric bridging and dead zones during powder recirculation.

9. The apparatus of claim 1, wherein the mirror-polished internal surface of the hopper is characterized by a surface roughness Ra of 0.05 micrometers or less, reducing the coefficient of friction and minimizing mechanical interlocking between residual trichomes and the hopper surface.

10. A method for electrostatic separation of glandular trichomes from a sample of trichome-bearing plant biomass comprising:
dispensing a sample containing glandular trichomes into a vertically oriented free-fall pathway to enable gravitational descent of the sample through a particle transport assembly that is substantially linear and free of coiled or spiral conduits;
maintaining steady-state flow conditions through a laminar diffuser configured to declump and disperse particles into a uniform flow without artificial triboelectric charging;
introducing the dispersed particles into a separation chamber comprising a pair of oppositely charged electrode assemblies configured to generate an electrostatic field for deflecting glandular trichomes toward a collector surface while allowing non-target biomass to pass through under gravity;
positioning a pair of discharge electrodes below the separation chamber and adjacent to the free-falling particle stream to neutralize residual charge on particles exiting the separation chamber, thereby preventing electrostatic clumping and wall adhesion;
directing the neutralized particles into a hopper having a mirror-polished internal surface and rounded internal corners configured to prevent bridging and enable continuous flow of the recovered sample; and
periodically actuating a vibration mechanism coupled to at least one of the hopper and the laminar diffuser to dislodge accumulated particles, maintain laminar flow conditions, and ensure uninterrupted recirculation of the sample through the separation process.

11. The method of claim 10, wherein the sample comprises particles having an average size between 20 and 300 micrometers and a moisture content maintained between 5 and 15 percent by weight to ensure consistent electrostatic response during free fall.

12. The method of claim 10, wherein the laminar diffuser comprises a perforated diffuser plate configured to regulate airflow velocity and create a uniform laminar flow field across the cross-section of the separation chamber.

13. The method of claim 12, wherein the laminar diffuser is periodically vibrated at a frequency between 1 and 60 hertz to dislodge adhered particles and prevent diffuser clogging caused by resinous or adhesive biomass.

14. The method of claim 10, wherein the electrode assemblies comprise elongated conductive plates oriented vertically and having a length-to-width ratio of at least 2:1 to increase residence time and separation efficiency of the descending particles.

15. The method of claim 14, wherein each electrode plate has a surface finish characterized by an Ra between 0.8 and 1.2 micrometers and an Rz between 4.0 and 6.0 micrometers, providing controlled roughness that temporarily traps trichomes and enhances selective adhesion.

16. The method of claim 10, wherein the discharge electrodes comprise a pair of corona discharge devices positioned laterally adjacent to the falling particle stream to neutralize residual charge immediately downstream of the separation chamber.

17. The method of claim 10, wherein the hopper includes at least one pneumatic turbine or electrical vibrator configured to oscillate the hopper body and promote consistent downward powder flow into the recirculation system.

18. The method of claim 17, wherein the hopper interior comprises continuous curved surfaces having fillet radii of at least 25 millimeters and a circular outlet configured to prevent bridging and stagnant powder zones during continuous operation.

19. The method of claim 18, wherein the internal surfaces of the hopper are mirror-polished to a surface roughness Ra of 0.05 micrometers or less to reduce frictional adhesion of trichomes and maintain uninterrupted particle recirculation.

20. A system for electrostatic separation of glandular trichomes from a sample of plant biomass comprising:
an electrostatic separation assembly configured in accordance with any of claims 1 or 10 and including a vertically oriented free-fall pathway, a laminar diffuser, at least one pair of oppositely charged electrode assemblies, and a hopper for collection and recirculation of separated material;
at least one sensor configured to monitor operational parameters including particle flow rate, vibration frequency, electrostatic field strength, and temperature within the separation chamber;
a control unit operatively coupled to the sensor and configured to regulate at least one of the vibration frequency of the diffuser or hopper, the potential applied to the electrode assemblies, or the operation of the discharge electrodes to maintain a desired separation efficiency; and
a feedback circuit comprising a microprocessor or programmable logic controller executing an adaptive control algorithm configured to automatically adjust system variables in real time based on sensor feedback to sustain laminar flow conditions, prevent agglomeration, and optimize trichome purity in the collected output.
